(19) United States
(12) Patent Application Publication
(10) Pub. No.: US 2010/0277892 A1
(43) Pub. Date: Nov. 4, 2010

(54) POWER DEVICE WITH LIGHTED OUTLETS

(75) Inventors: Vladimir Vladimirovich Konopelko, Narragansett, RI (US); Patrick Aaron Donovan, East Greenwich, RI (US); Meng-Chang Liu, Puli Township (TW)

Correspondence Address: LANDO & ANASTASI, LLP;A2000, One Main Street, Suite 1100, Cambridge, MA, 02142, US

(73) Assignee: American Power Conversion Corporation, West Kingston, RI (US)

(21) Appl. No.: 12/434,156

(22) Filed: May 1, 2009

(51) Int. Cl. F21V 33/00

(52) U.S. Cl. 362/95

(57) ABSTRACT

A power device having illuminated power outlets is disclosed. The power device includes a housing, a power input interface to the housing, and a plurality of power outlets on the housing for distributing power from the input. Within the housing of the power device, a printed circuit board has at least one LED positioned adjacent to at least one of the plurality of outlets to illuminate the openings of the outlets from within the interior housing.

### BACKGROUND

1. Field of the Invention

At least one embodiment in accordance with the present disclosure relates generally to power devices, such as power strips, power distribution units, and uninterruptible power supplies (UPS), having illuminated outlet openings.

2. Discussion of Related Art

Many electronic and electrical systems, such as computer and home entertainment systems require that electrical power be supplied to various components of the system. The use of power devices, such as power strips, power distribution units, and uninterruptible power supplies (UPS) to supply power is known.

Power strips are a strip of power outlets that receive power from a power source and allow multiple devices to be plugged into the various outlets on the strip to distribute that power. In some instances, the power strips have a flexible cable with a plug attached to be engaged into a power source, such as a wall outlet. In other instances, the power strip has a “wall-tap” type design where the device is connected directly to a wall outlet duplex without the use of a cord. In the “wall-tap” design, the plug has prongs are flush against the rear housing of the unit, and no cord or cable is necessary. In addition to providing power to the devices, the power strip may also provide power surge protection. Power distribution units (PDU) often refer to large industrial power strips constructed for use in data centers.

Uninterruptible power supplies provide regulated, uninterrupted power for sensitive and/or critical loads, such as computer systems and other data processing systems, is known. A number of different UPS products are available including those identified under the trade name Smart-UPS® from American Power Conversion Corporation of West Kingston, R.I. In a typical UPS, a battery is used to provide backup power for a critical load during blackout or brownout conditions.

### SUMMARY OF THE INVENTION

When power devices are located in dark room, or in places where they may have limited visibility, such as below a table or behind a shelf, identifying the outlet locations may be difficult, making it challenging to engage a plug into the outlet. Aspects in accord with the present invention provide power devices with illuminated outlet openings that provide better recognition to allow a user to identify an outlet and engage it with a plug.

According to principles of the invention, a power device includes a housing, a power input interface to the housing, and a plurality of power outlets on the housing for distributing power from the input. Within the housing of the power device, a printed circuit board has at least one LED positioned adjacent to at least one of the plurality of outlets to illuminate the openings of the outlets from within the interior housing.

The power device could be any electronic device that provides power through multiple outlets. Examples of power devices include, but are not limited to, surge protectors, power conditioners, power strips, power distribution units (PDU), or uninterruptible power supplies (UPS).

In embodiments consistent with principles of the invention, printed circuit boards in the power devices may have LEDs positioned adjacent to each of the plurality of outlets in the power device. In some embodiments, the LED in the power device may be activated by a light sensor. The power device may include a battery, from which the LEDs draw power, and in some circumstance may also provide battery power for a UPS.

In some embodiments, the outlets of the power devices are located on a face of the housing, the face being formed from non translucent material. In other embodiments the entire housing of the power device is formed from non-translucent material.

### BRIEF DESCRIPTION OF DRAWINGS

The accompanying drawings are not intended to be drawn to scale. In the drawings, each identical or nearly identical component that is illustrated in various FIGs. is represented by a like numeral. For purposes of clarity, not every component may be labeled in every drawing. In the drawings:

FIG. 1A is a view of a power device in which principles of the invention may be embodied;

FIG. 1B is an exploded view of the power device of FIG. 1A;

FIG. 2 is a view of a printed circuit board that may be used in a power device, such as the device in FIGS. 1A and 1B;

FIG. 3A is a view of another power device in which principles of the invention may be embodied;

FIG. 3B is an exploded view of the power device of FIG. 3A; and

FIG. 4 is a view of a printed circuit board that may be used in a power device, such as the device in FIGS. 3A and 3B;

### DETAILED DESCRIPTION

At least some examples in accordance with the present invention relate to systems and processes for providing improved control, monitoring and/or configuration of uninterruptible power supplies.

The aspects disclosed herein in accordance with the present invention, are not limited in their application to the details of construction and the arrangement of components set forth in the following description or illustrated in the drawings. These aspects are capable of assuming other examples and of being practiced or of being carried out in various ways. Examples of specific implementations are provided herein for illustrative purposes only and are not intended to be limiting. In particular, acts, elements and features discussed in connection with any one or more examples are not intended to be excluded from a similar role in any other examples.

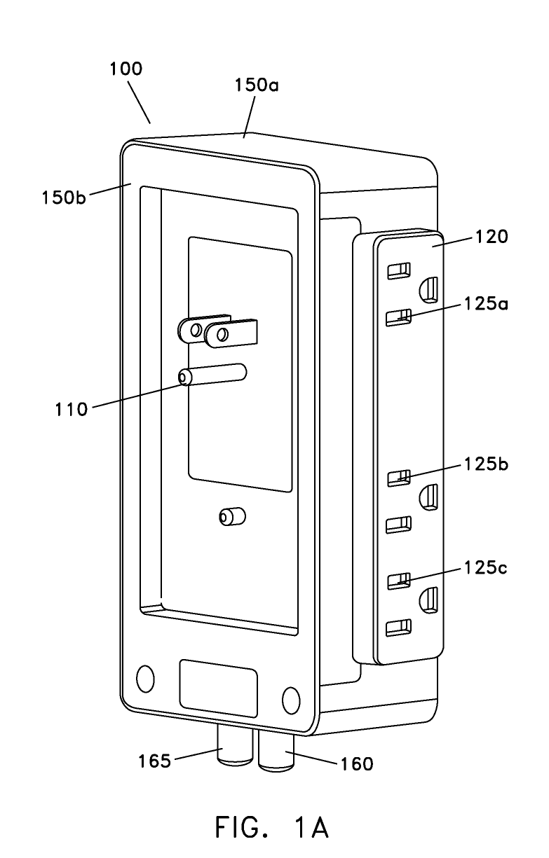

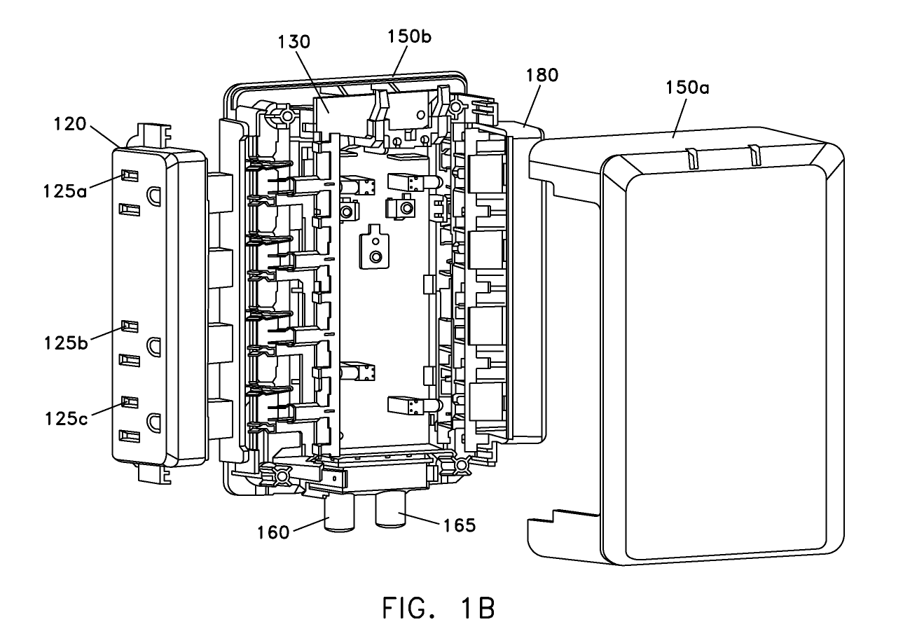

FIG. 1A shows a surge protector 100 according to an embodiment that is consistent with principles of the invention. The surge protector 100 has a housing comprised of a front housing component 150a and a back plate 150b. On the rear of the surge protector 100 is a plug 110 that can be inserted into a typically wall outlet (not shown). The plug 110 serves as a power input to the surge protector. On the housing, outlet faceplate 120 has power outlets 125a, 125b and 125c. Surge protector 100 further has a coaxial input port 160 and a coaxial output port 165 that may be used to provide surge protection through data lines.

FIG. 1B provides an exploded view illustration of the surge protector 100 of FIG. 1A. In this exploded view, another outlet faceplate 180 is located on the opposite side of the housing of the outlet faceplate 120. Outlet faceplate 180 also has power outlets (not shown in FIG. 1B). Within the housing of the surge protector 100 is printed circuit board 130. Along with the circuitry that provides for the distribution of power from the AC input coming in through the plug 110, and any other surge protection functionality, the printed circuit board has four embedded Light Emitting Diodes (LEDs) 135a-d that are positioned adjacent to the power outlet openings. The LED 135a is positioned such that light illuminating from the diode will light the three openings of power outlet 125a.

In some embodiments, the LEDs may be powered through AC power from the input, or alternatively through battery power (the power path through the printed circuit board 130 not shown). In other embodiments, the LEDs may draw power and continuously illuminate the outlet openings, or they may be switched by a light sensor (not shown in FIG. 1A or FIG. 1B.)

By having the openings of the outlets 125a-c on the surge protector 100 illuminated, a user may be able to easily locate the outlets in the dark, or in some visually obscured location, such as underneath a table or desk. This prevents a user from having to resort to the risky “feel and plug” approach that can result in electric shock. Further, by specifically lighting the outlet openings, rather than the entire surge protector 100 or outlet faceplate 120, specific visual guidance is provided for enabling a user to more easily engage a plug into illuminated openings of the outlets 125a-c. In some embodiments, the faceplate 120 is made of non-translucent material to allow the illuminated holes of the outlet to have more visual definition. In other embodiments the entire housing is made of non-translucent material to further highlight the outlet hole openings. It is preferably that the LEDs are not of such high intensity brightness to illuminate the openings in manner that the distinct holes of the outlets are not obscured by the brightness.

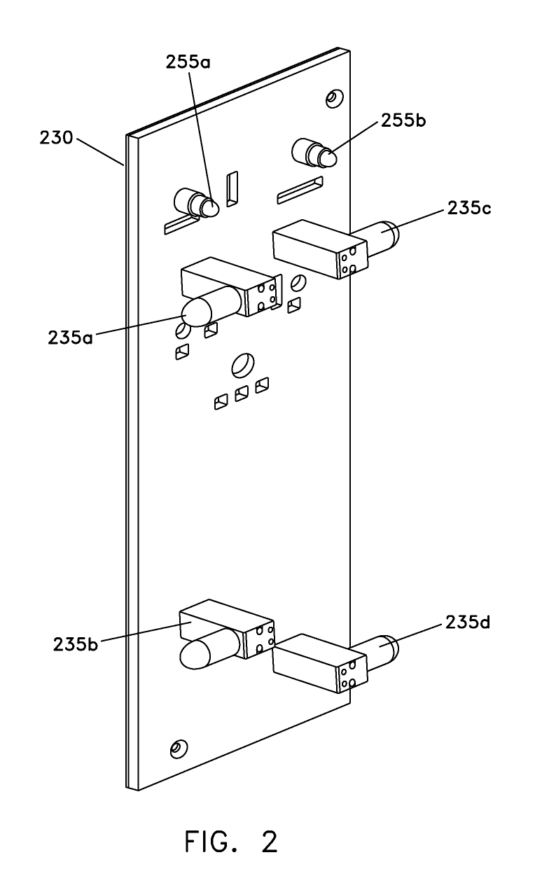

FIG. 2 illustrates a printed circuit board 230 that may be used in a power device, such as the device in FIG. 1A and FIG. 1B. The printed circuit board 230 has multiple LEDs fixed on the board. LEDs 235a-d are fixed on the board such that they will illuminate through an outlet (not shown in FIG. 2) perpendicular to the front plane of the printed circuit board 230. The printed circuit board 230 also has two LEDs 255a and 255b that are fixed such that they will illuminate along the face of the printed circuit board 230. The LEDs 255a and 255b may be used as indicator lights on the face of the power device to indicate any number of status messages, such as “power is available,” or “surge protection is working.” One of skill in the art will recognize that the LEDs for illuminating outlets may be positioned to illuminate perpendicular to the printed circuit board face, or from the printed circuit board face, so long the direction of their illumination is through outlet holes.

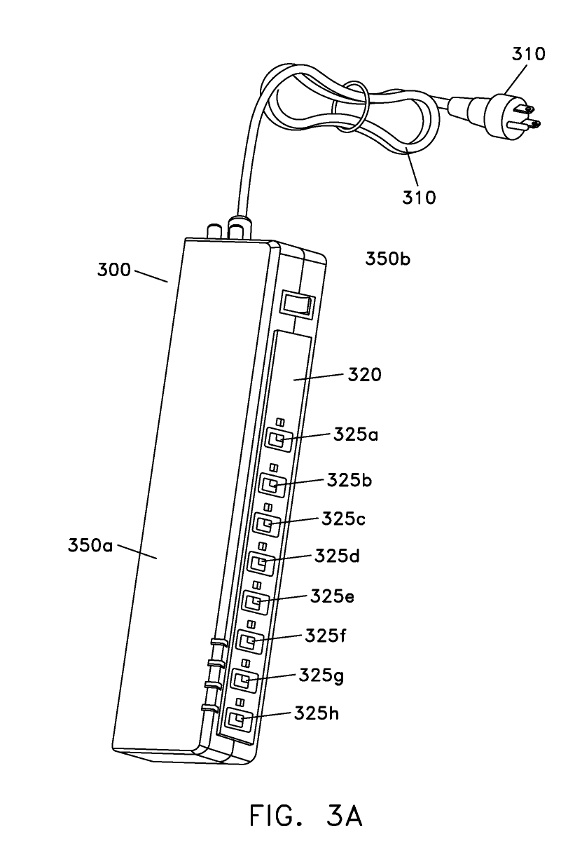

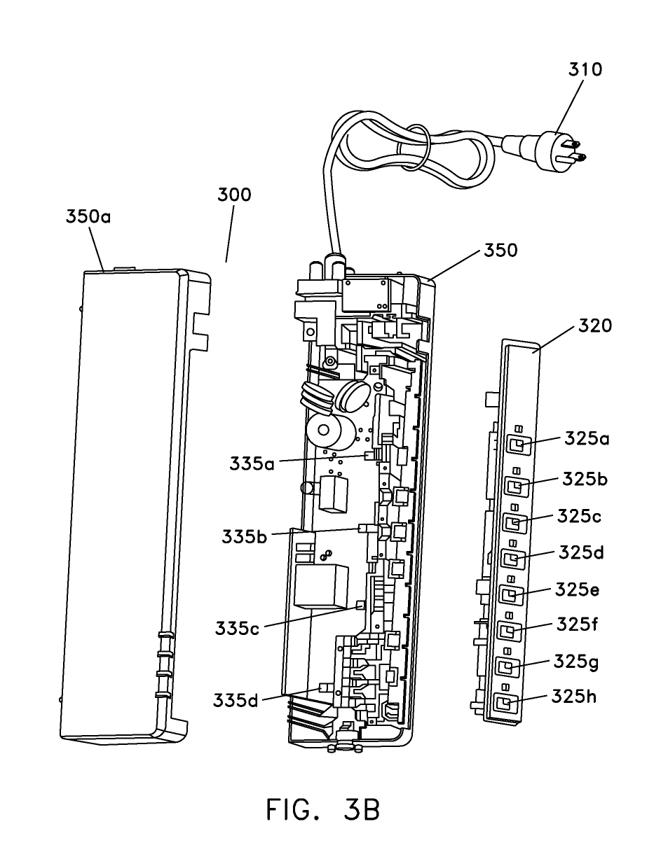

FIG. 3A shows a power strip 300 according to another embodiment consistent with principles of the invention. The power strip 300 has a housing comprised of a front plate 350a and a back housing component 350b. The power strip 300 includes a plug 310 that extends from the housing from a cord 370. Similar to the plug 110 of surge protector 100 of FIG. 1A, the plug 310 can be inserted into a wall outlet (not shown). However, one of skill in the art will understand that other embodiments of the invention may include power inputs that may be power from other power sources. The plug 310 serves as the power input to the power strip 300. Power strip 300 has power outlets 325a-h located on outlet faceplate 320.

FIG. 3B provides an exploded view illustration of the power strip 300 of FIG. 3A. Within the housing of the power strip 300 is printed circuit board 130. Along with the circuitry that provides for the distribution of power from the AC input coming in through the plug 310 and cord 370, and any other device functionality, the printed circuit board has four embedded Light Emitting Diodes (LEDs) 335a-d that are positioned adjacent to the power outlet openings. The LED 335a is positioned such that light illuminating from the diode will light the three openings of power outlet 325a.

By having the openings of the outlets 325a-c on the power strip 300 illuminated, a user may be able to easily locate the outlets in the dark, or in some visually obscured location, such as underneath a table or desk. This prevents a user from having to resort to the risky “feel and plug” approach that can result in electric shock. Further, by specifically lighting the outlet openings, rather than the entire power strip 300 or outlet faceplate 320, specific visual guidance is provided for enabling a user to more easily engage a plug into illuminated openings of the outlets 125a-c.

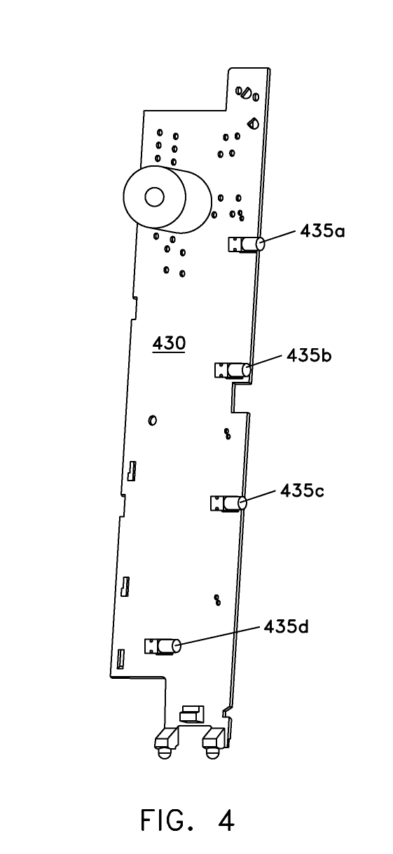

FIG. 4 illustrates a printed circuit board 430 that may be used in a power device, such as the device in FIGS. 3A and 3B. The printed circuit board 430 has multiple LEDs fixed on the board. LEDs 435a-d are fixed on the board such that they will illuminate through outlet (not shown in FIG. 4) perpendicular to the front plane of the printed circuit board 430.

Any reference to examples, elements or acts of the systems, machines and processes herein referred to in the singular may also embrace examples including a plurality of these elements, and any references in plural to any example, element or act herein may also embrace examples including only a single element. References in the singular or plural form are not intended to limit the presently disclosed systems, machines or processes, their components, acts, or elements.

Any example disclosed herein may be combined with any other example, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. Such terms as used herein are not necessarily all referring to the same example. Any example may be combined with any other example in any manner consistent with the aspects disclosed herein. References to “or” may be construed as inclusive so that any terms described using “or” may indicate any of a single, more than one, and all of the described terms.

Where technical features in the drawings, detailed description or any claim are followed by references signs, the reference signs have been included for the sole purpose of increasing the intelligibility of the drawings, detailed description, and claims. Accordingly, neither the reference signs nor their absence are intended to have any limiting effect on the scope of any claim elements.

Examples of the invention have been described herein for use with surge protection and power strip devices. Other examples may be used with Power Distribution Units (PDU) or Uninterruptible Power Supplies (UPS), or any electronic device that provides power through multiple outlets. Depending on their internal circuitry and design, each power device may provide different functions, such as surge protection, power conditioning, and/or power shedding, or have different features. In the case of a UPS, the UPS includes a back up battery, from which the LEDs may be powered. In the case of a PDU, the power input may be single phase power or a plural phase power (typically 3-phase power).

Having thus described several aspects of at least one example of this invention, it is to be appreciated various alterations, modifications, and improvements will readily occur to those skilled in the art. Such alterations, modifications, and improvements are intended to be part of this disclosure, and are intended to be within the scope of the invention. Accordingly, the foregoing description and drawings are by way of example only.

What is claimed is:

1. A power device comprising:
a housing;
a power input interface to the housing;
a plurality of power outlets on the housing for distributing power from the input;
a printed circuit board in the housing, the printed circuit board having an LED positioned adjacent to at least one of the plurality of outlets to illuminate the openings of the outlets from within the interior housing.

2. The power device of claim 1 wherein the printed circuit board has an LED positioned adjacent to each of the plurality of outlets.

3. The power device of claim 1 wherein the LED is activated by a light sensor.

4. The power device of claim 1 wherein the power device is a surge protector.

5. The power device of claim 1 wherein the power device is a power conditioner.

6. The power device of claim 1 wherein the power device is a power strip.

7. The power device of claim 1 wherein the power device is a power distribution unit.

8. The power device of claim 1 wherein power device further includes a battery.

9. The power device of claim 8 wherein the LED is powered by the battery on the UPS.

10. The power device of claim 8 wherein the power device is a UPS.

11. The power device of claim 1 wherein the plurality of outlets are located on a face of the housing, the face being formed from non translucent material.

12. The power device of claim 1 wherein the entire housing is formed from non-translucent material.
